(19) United States
(12) Patent Application Publication
(10) Pub. No.: US 2020/0064883 A1
(43) Pub. Date: Feb. 27, 2020

(54) DEVICE AND METHOD FOR APPLYING PROTECTIVE FILMS

(71) Applicant: Christopher SCHWENKE, Schalchham (AT)

(72) Inventor: Christopher SCHWENKE, Schalchham (AT)

(21) Appl. No.: 16/498,566

(22) PCT Filed: Mar. 27, 2018
(86) PCT No.: PCT/EP2018/000122

§ 371 Date: Sep. 27, 2019

Related U.S. Application Data
(60) Provisional application No. 62/477,352, filed on Mar. 27, 2017.

(51) Int. Cl. G06F 1/16

(52) U.S. Cl. CPC G06F 1/1609; G06F 1/1628

(57) ABSTRACT

The present technology provides a device for applying films to displays or other surfaces of apparatuses such as phones and tablets, for example. The device includes a frame and a multi-layer pad including an adhesive film. The pad is coupled with the frame along an edge. The frame can be clamped or otherwise coupled with the apparatus. When properly coupled, the frame and the apparatus register with a certain tolerance and the film registers easily with the apparatus when taut and laid down beginning distal of the edge that is coupled with the frame while the film close to the edge remains slightly elevated from the apparatus to facilitate the application process. The whole film can then be pasted onto the apparatus using a suitable spatula, for example. The device allows for reliable registration between adhesive film and apparatus and reduces inclusion and bubble formation during application.

### FIELD OF THE TECHNOLOGY

The present technology is directed to effective application of protective films on surfaces of various apparatuses.

### BACKGROUND OF THE TECHNOLOGY

Protective films are commonly applied to maintain the condition and appearance of underlying surfaces. Such films are typically configured to provide some form of self-adhesion with the surface that they seek to protect. Some films are configured to be readily removable with little residue. Easy removability is typically desirable were the protective film is configured as a replaceable wear item. Compared to the object they are intended to protect, such films are typically inexpensive and designed to be replaced when their appearance is deteriorated. Such films are particularly common to protect the surface of displays or other exterior surfaces of mobile or personal computer devices, for example cellular phones and tablet computers. Proper alignment and a film application that is free from bubbles and inclusions are particularly important to maintain visibility and homogenous appearance of laminated device displays.

Proper alignment, avoidance of bubble formation and dust particle inclusions can turn the application of protective films into a daunting process. Due to wear and repeat film replacement of mobile and personal computer devices, actual protective film application is usually left to the end user and is often performed in environments where the presence of dust cannot be avoided. As such devices that facilitate proper alignment with speedy and bubble-free film application are desirable. Various solutions have been proposed to address these problems:

For example, International Patent Application Publication No. WO 2014/167433 to Gawlowski describes a method and device for placing a layer of protective foil over the screen of a telephone or other portable device, for example. Gawlowski's device, however, is bulky and only allows sudden deposition of the whole film across its full extension and hence is prone to formation of trapped bubbles.

United States Patent Application Publication No. US 2016/0009024 to Mason, describes an applicator for applying protective films to electronic device displays. The applicator includes a base, a screen protector, and a squeegee. The base includes a pocket for receiving an electronic device. The screen protector is affixed to the base to overlie the electronic device. The screen protector includes three layers including a protective film, cap sheet and back liner. The back liner includes one or two tags which extend beyond the edge of the protective film to allow the user to manually peel the back liner from the protective film. The squeegee is provided for removing the back liner and for simultaneously affixing the protective film to an electronic device. Mason's applicator, however, is bulky, complicated, and difficult to operate.

Chinese Patent No. CN 203345234 to Wang discloses a film pasting device which comprises a base, a roller wheel seat and a stripping roller. The base is provided with a device positioning cavity, a sliding channel, a front positioning groove and a positioning pillar. The roller wheel seat is composed of a roller wheel shell, a stripping-assisting part and a roller. A roller shaft seat, a clamping groove and a sliding rail are arranged on the roller wheel shell. A roller is arranged in the roller shaft seat. The stripping-assisting part is composed of an L-shaped sheet and double positioning arms. The included angle between the L-shaped sheet and the double positioning arms ranges frame 45 degrees to 60 degrees. When the L-shaped sheet is inserted into the clamping groove of a roller wheel device, a plain end line of the lower rim of the L-shaped sheet is 5 mm to 8 mm away from the bottom plane of the roller wheel seat and positioned above the roller wheel shell. The roller wheel seat is installed on the front of the base and slides on the sliding channel. Like Mason's applicator, Wang's film pasting device is bulky, complicated, and difficult to operate.

European Patent Application Publication No. EP 2730992 to Hsu et al. describes an application apparatus and a screen protector. The application apparatus is a frame-like structure with an internal hollow region for containing the screen protector that is configured to attach an adhesive film to an electronic device by sliding the application apparatus over an outer contour of the electronic device after peeling a release layer from under the adhesive film. The application apparatus of Hsu et al. is unreliable as it seeks to accomplish registration between the film and the electronic device while applying the adhesive film suddenly across the whole extension of the film and is prone to bubble formation.

United States Patent Application Publication No. US 2016/0176101 to Fan describes a positioning device suitable for auxiliary positioning when pasting a screen protecting film to an electronic device with a functional port in its bottom end surface and a button on its front surface adjacent to the functional port. Fan's positioning device is flimsy, provides poor film registration and is prone to bubble formation.

United States Patent Application Publication No. US 2009/0186181 to Mase discloses a multilayer protective film including a split adhesive layer configured to facilitate initial alignment and to provide surface cleaning by sacrificial peeling of the split adhesive layer in preparation for the application of a second adhesive layer intended for actual protection of electronic device screen. Mase's multilayer protective film requires manual film alignment and entails an elaborate application procedure while it relies on the durability of the alignment of the initially applied split adhesive layer until the application of the second adhesive layer is complete. As such it is prone to alignment errors and cumbersome in its application.

Chinese Patent Application Publication No. CN 105314153 to Wu is an example describing a method for applying a protective film using removable adhesive stickers configured as an aid to align the film with an edge of a mobile phone in preparation for the film application. Wu's method only allows for sudden deposition of the whole film on the mobile phone surface and hence is prone to bubble formation.

### SUMMARY OF THE TECHNOLOGY

An object of the present technology is to provide a device for applying protective films. In accordance with one aspect of the present technology, there is provided a device comprising a frame configured to couple removably with an apparatus in an attached configuration; and an adhesive film having a first portion removably coupled with the frame and a second portion spaced apart from the first portion. The adhesive film is configured to adhere to a target surface of the apparatus. In the attached configuration when the adhesive film is taut and the second portion is abutting the target surface of the apparatus, the first portion is being held a distance away from the surface of the apparatus and the second portion registers in a predetermined manner with the target surface of the apparatus.

### BRIEF DESCRIPTION OF THE DRAWINGS

FIG. 1 shows a perspective view of an assembly of a mobile phone with an example film-application device according to the present technology.

FIG. 2 shows an exploded perspective view of the assembly of FIG. 1.

FIG. 3 shows a perspective view of the assembly of FIG. 1 as seen from below.

FIG. 4 shows an exploded view of several example multi-layer pads according to the present technology.

FIG. 5 shows a side view of the assembly of FIG. 1 on a support surface.

FIG. 6 shows a perspective view of another example film-application device according to the present technology.

FIG. 7A shows a perspective view of another example film-application device according to the present technology.

FIG. 7B shows a perspective view of another example film-application device according to the present technology.

FIG. 7C shows a perspective view of the bottom of the example film-application device of FIG. 7B.

FIG. 7D shows an exploded view of parts of the example film-application device of FIG. 7B.

FIG. 8 shows a perspective view of another example film-application device according to the present technology.

FIG. 9 shows a perspective view of another example film-application device according to the present technology.

FIG. 10A shows a perspective view of the assembly of FIG. 1 with a lifted pad with a partially peeled bottom film.

FIG. 10B shows a perspective view of the assembly of FIG. 1 with a taut pad abutting the mobile phone.

FIG. 10C shows a perspective view of the assembly of FIG. 1 with a partially pasted protective film and a spatula used to aid pasting.

FIG. 10D shows a perspective view of the assembly of FIG. 1 with a partially peeled top film.

FIG. 10E shows a perspective view of the assembly of FIG. 1 with a fully peeled top film.

FIG. 10F shows a perspective view of the assembly of FIG. 10E after separation.

### DETAILED DESCRIPTION OF THE TECHNOLOGY

The present technology provides a device for applying films to displays or other target surfaces of apparatuses such as phones, tablets, laptop and desktop computers, wrist watches, cameras, televisions, measuring instruments or other apparatuses, for example. The device includes a frame and a multi-layer pad including a protective adhesive film. In some implementations, the protective adhesive film is transparent. The pad with the adhesive film is supported and removably coupled with the frame, for example along an edge of the film. The frame is configured to be clamped or otherwise coupled with the apparatus. When fully coupled, the frame and the apparatus can register accurately within a certain tolerance and in turn the film can accurately register with the target surface of the apparatus. When taut, the adhesive film can be laid down beginning distal of the supported edge that is coupled with the frame while the portion of the adhesive film near the supported edge is kept slightly elevated by a predetermined distance above the target surface by the frame to facilitate the application process. After its distal edge has been attached, the adhesive film can then be pasted onto the apparatus using a suitable spatula or other aid. In some implementations, the application of the protective adhesive film can be completed and the apparatus separated from the frame after peeling a sacrificial top film from the protective adhesive film.

The film-application device allows for reliable registration between the adhesive film and the target surface of the apparatus and can mitigate inclusion and bubble formation during film application. The present device and application process can provide pasted adhesive film that is free from visible imperfections.

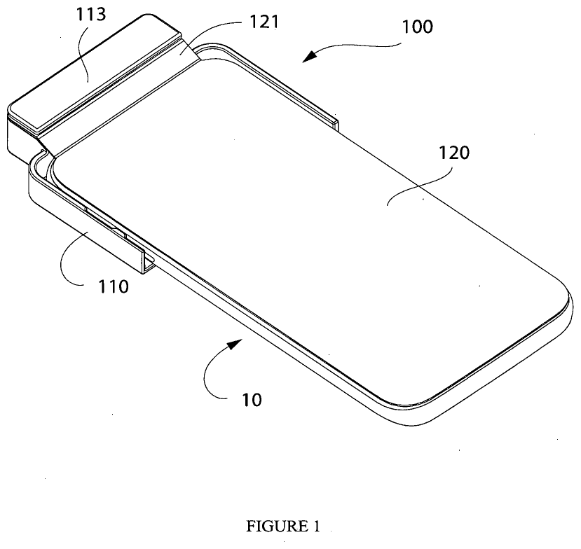

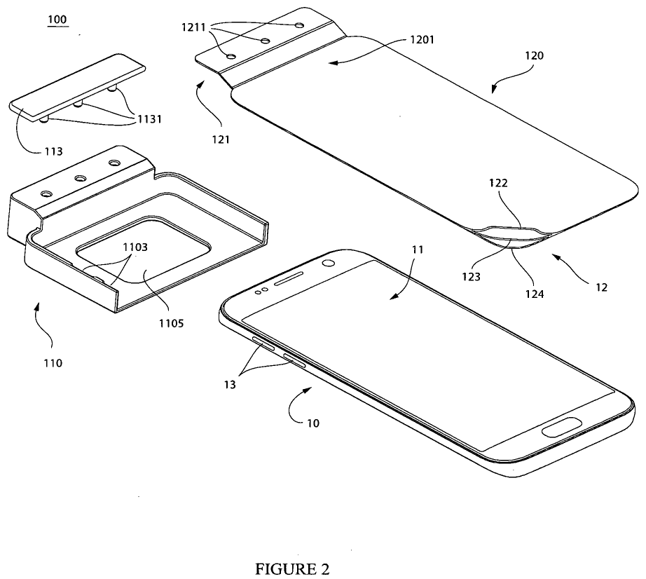

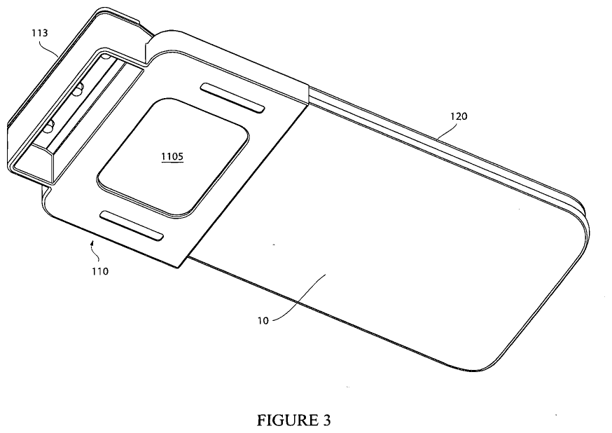

FIG. 1 shows a perspective view of an assembly of an example film-application device 100 according to the present technology with an inserted mobile phone 10. FIG. 2 shows an exploded perspective view of the assembly of FIG. 1. FIG. 3 shows a perspective view of the assembly of FIG. 1 from below.

The example film-application device 100 is configured for application of a protective film to a target surface 11 provided by a front face of a mobile phone 10. In this example, the target surface 11 includes the display and other areas of the front face but omits buttons, cameras, speakers and light sources. In some examples, the target surface includes only the display of the mobile phone.

The film-application device 100 includes a frame 110 with a cap 113 and a multi-layer pad 120. FIG. 1 shows the multi-layer pad 120 resting on the mobile phone 10. In this example, the multi-layer pad 120 includes a tab 121, a top film 122, a bottom film 124 and a transparent protective adhesive film 123. The transparent protective adhesive film 123 is configured to extend across the target surface 11 and includes corresponding apertures (not illustrated) to accommodate various elements on the front face of the mobile phone 10 as noted above. Depending on the implementation, one or more of the three films 122, 123 and 124 may be opaque, translucent, or partially or fully transparent, for example. For example, the top film 122 may be transparent and have a bluish or other color hue that enhances contrast versus the target surface 11. Good contrast can aid the user in the recognition of features such as edges and apertures of the target surface 11 and the pad 120 during film application and hence facilitate the registration of the transparent protective adhesive film 123 with the target surface 11.

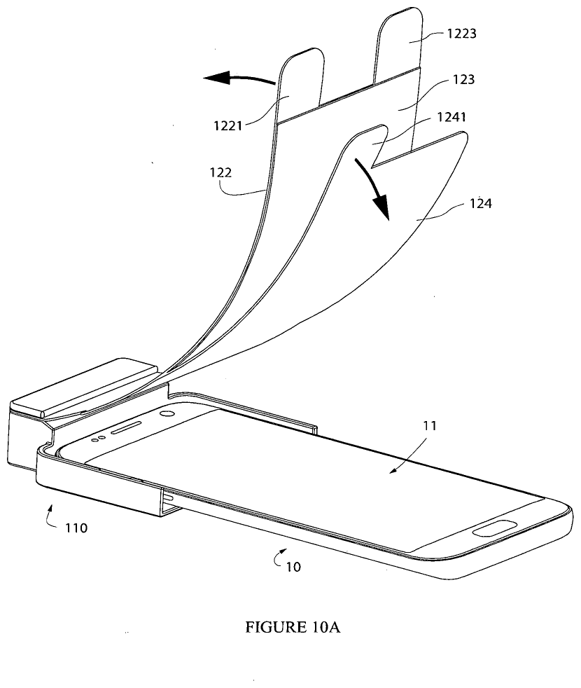

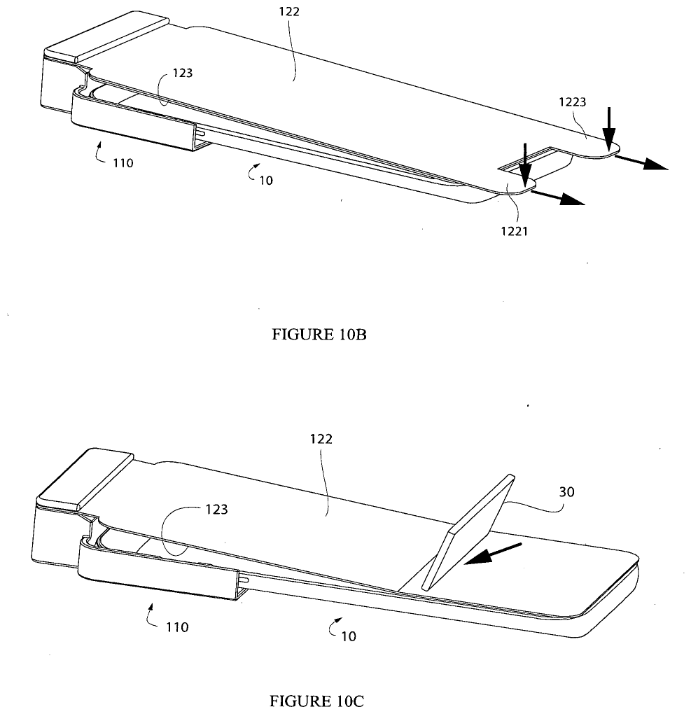

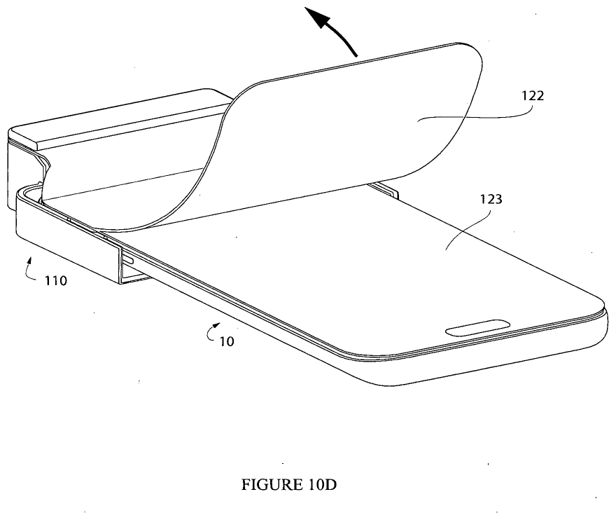

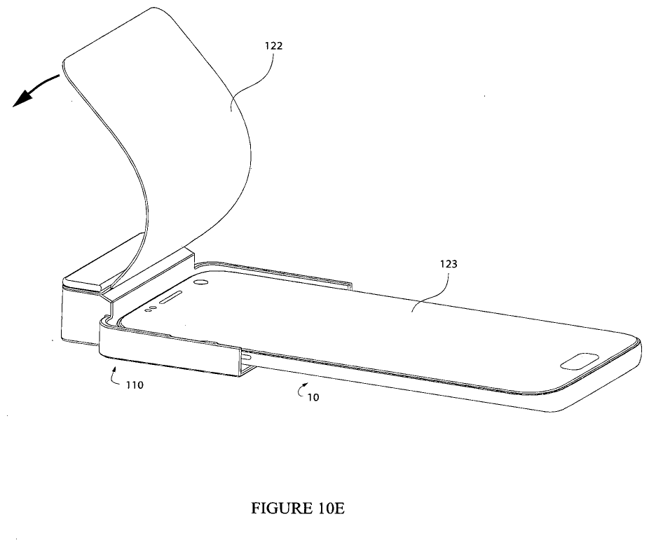

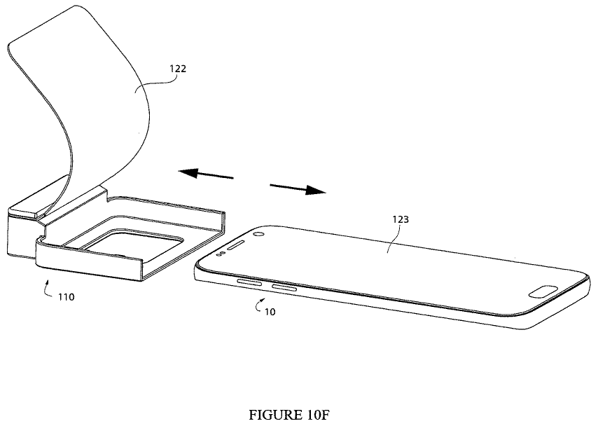

In FIG. 1, the multi-layer pad 120 is shown to rest on the mobile phone 10. Features in or under the multi-layer pad 120 are not illustrated. FIG. 2 shows the multiple films 122, 123 and 124 schematically fanned out at a corner 12. The multi-layer pad 120 further includes protruding tabs 1221, 1223 and 1241 (see FIGS. 10A and 10B) configured to facilitate separation of the multiple films 122, 123 and 124 by peeling. In this example, the tabs 1221, 1223 and 1241 are formed from separate strips of suitable material adhered to respective films. The separate nature and adhesion of the tabs with the films are not indicated in FIGS. 10A and 10B. The tabs 1221 and 1223 are adhered to the top of and protrude from the top film 122, the tab 1241 is adhered to the bottom of and protrudes from the bottom film 124. The multi-layer pad 120 can be fabricated from a sandwiched web material that includes films 122, 123 and 124 and is die cut to fit the target surface 11. Tabs 1221, 1223 and 1241 then can be adhered after die cutting. In other examples, tabs may be formed integrally with like or other films of respective multi-layer pads. Generally, one or more of the top, bottom and/or the transparent protective adhesive films may be provided with one or more tabs in various combinations to facilitate separation.

The frame 110 is shaped to clamp resiliently to the mobile phone 10 by grabbing onto a U-shaped portion of the circumference of the mobile phone 10 and includes indentations 1103 and an opening 1105 to accommodate buttons 13, camera components (not illustrated) or other elements protruding from the mobile phone 10. The frame 110 is configured so it can hold the taut pad 120 with the transparent protective adhesive film 123 slightly elevated by a certain distance above the target surface 11 near the supported edge 1201.

In this example, the frame 110 near the supported edge 1201 is slanted in a flat manner. The recess and height of the slant may be configured to control a remaining amount of transparent protective adhesive film 123 that may only be applied at like distances to the target surface 11 after the mobile phone 10 and the frame 110 are separated. Further details about the film application process are described with respect to FIGS. 10A through 10F. Other example film-application devices may have edges with different or no slants.

Initially, the transparent protective adhesive film 123 is sandwiched between the top film 122 and the bottom film 124. The top film 122 and the bottom film 124 are configured to protect the transparent protective adhesive film 123 from dust and scratches for example, until it is pasted onto the target surface 11 of the mobile phone 10. In this example, the tab 121 is formed from a separate strip of suitable material adhered to the top of the top film 124 to form a protrusion of the pad 120 and is configured to engage and reliably register the pad 120 with the frame 110 along the supported edge 1201. The separate nature and adhesion of the tab 121 with respect to the top film 124 are not indicated in the figures. The tab 121 includes three openings 1211 configured to mate with protrusions 1131 provided by a cap 113. The frame 110 has like openings 111 configured to mate with the protrusions 1131 of cap 113 so that the multi-layer pad 120 can be coupled accurately to the frame 110. In other implementations, the tab 121 can be formed as an integral protrusion of the top film, for example.

Depending on the implementation, the pad 120 can be securely coupled to the frame 110 via the cap 113 during manufacture or later by an end user, for example. A respective coupling may be established by welding or a friction fit, for example. Depending on the implementation, respective parts may be removable or irremovable by the end user. Film-application devices with a removable cap can be used to secure suitable pads onto the frame by the end user.

In other example film-application devices the pad may be coupled with the frame in other ways. For example, the bottom film may be split into a portion proximate the supported edge that includes a tab secured to the frame and a distal portion that can be peeled away independently to allow exposing a portion of an adhesive side of a respective protective adhesive film and initial placement and adhesion of same on the target surface distal of the supported edge. In some embodiments, protective adhesive film may be directly coupled to the frame and include a predetermined break line configured to allow separation of the protective adhesive film from the frame.

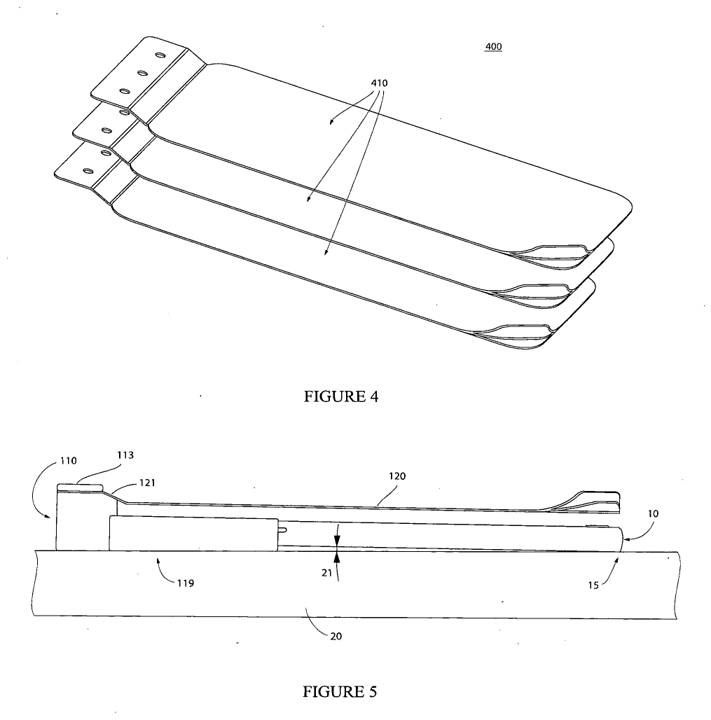

The example film-application device 100 of FIG. 1 is shown to include a single multi-layer pad 120 which allows one film application. Other example film-application devices may include several multi-layer pads to allow reuse of the device for multiple film applications. Such example film-application devices may be used to replace worn protective adhesive films previously applied to target surfaces with protective adhesive films from remaining unused multi-layer pads. FIG. 4 illustrates an exploded view of an example pad package 400 including three multi-layer pads. Each of the pads 410 is shown schematically fanned out at respective corners. Such pad packages can be configured to include pads with one or more creases to allow easy folding away of unused pads during film application. One or more of the films of each pad further may include one or more protruding tabs (not illustrated) configured to facilitate separation of each pad. Such tabs may be located along one or more edges of respective films, for example distal of the frame. Depending on the implementation, pads and pad packages may be provided to an end user separately or already affixed to a film-application device. In implementations with several multi-layer pads, the pad that is closest to the inserted apparatus is being used during film application while any extra unused pads are folded away.

To provide solid support during film application, the frame 110 of the example film-application device 100 has a base 119 that is tapered at an angle 21 relative to a back surface of a properly attached mobile phone 10 to avoid rocking the assembly on a flat external support 20 such as a tabletop, for example. FIG. 5 illustrates an example. The angle 21 can be chosen to form a three-point support between an edge 15 of the mobile phone 10 and the base 119 of the frame 110. In this example, the base 119 has a flat bottom surface and is configured to establish solid contact with the support 20 when the mobile phone 10 is attached.

To further stabilize the assembly and mitigate slippage during film application, the base 119 and/or other portions of the frame 110 may optionally be provided with surfaces configured to increase friction between the frame 110 and the external support 20. Such surfaces may include one or more rubber, silicone or other slip-mitigating elements configured to increase adhesion to and/or friction (not illustrated) with the external support 20. In some implementations, such surfaces may include one or more adhesive strips which can be configured for single or multiple use.

### Further Example Implementations

FIGS. 6, 7A through 7D, 8 and 9 show a selection of further example film-application devices according to the present technology. FIG. 6 shows an example film-application device 600 similar to the example film-application device 100 but uses a long edge to both clamp the frame 610 to an apparatus and to support a multi-layer pad 620 with a protective adhesive film.

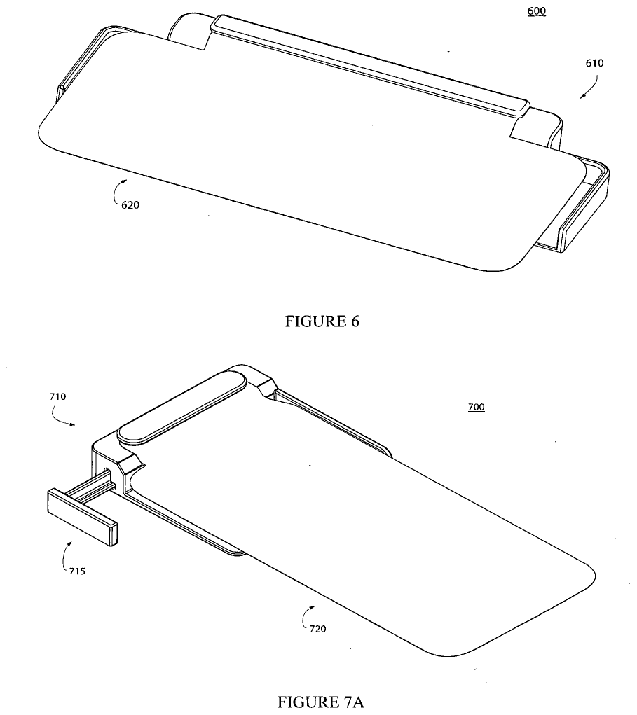

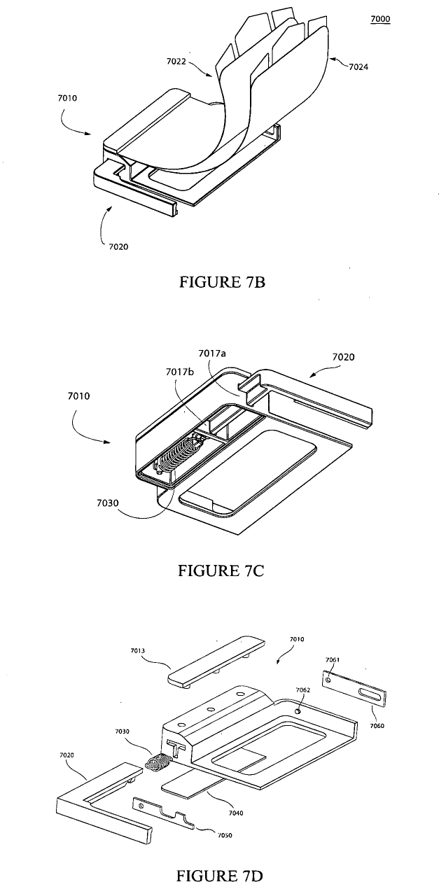

FIG. 7A shows another example film-application device 700 with a multi-layer pad 720, and a frame 710 that includes a retractable resiliently biased arm 715 configured to clamp and register an apparatus with the frame 710. Such biasing mechanisms (not illustrated here) can include a spring-loaded arm—see example in FIGS. 7B through 7D, or a friction fit arm engaging a rubber or other suitable frame insert, or a releasable anti-reverse mechanism including a toothed rack configured to engage a releasable ratchet pawl, for example. The retractable arm can be configured to attach to apparatuses of different width.

FIGS. 7B through 7D show various views of an example film-application device 7000 with a spring 7030, a spring-loaded arm 7020 and a frame 7010 and two multi-layer pads 7022 and 7024 with respective tabs. The film-application device 7000 is configured to attach apparatuses of different width. FIG. 7B shows the two multi-layer pads 7022 and 7024 fanned out. The spring-loaded arm 7020 has a T-shaped profile and the frame 7010 includes two ridges 7017a and 7017b with correspondingly shaped openings to guide the spring-loaded arm 7020 when assembled—see bottom view of the film-application device 7000 in FIG. 7C, for example. The frame 7010 is arranged to provide a chamber shaped to accommodate the spring 7030. In the assembled configuration, the spring-loaded arm 7020 is slidably coupled with the frame 7010 via noted openings in the ridges 7017a/b and the spring 7030 such that the spring-loaded arm 7020 can resiliently clamp and register an apparatus (not illustrated) with the frame 7010 in the attached configuration. In this example, the film-application device 7000 includes a bottom plate 7040 configured to close off the bottom of the frame 7010 and enclose the spring 7030.

The film-application device 7000 further includes a pair of inserts 7050 and 7060 best visible in FIG. 7D. There can be other numbers of inserts depending on the implementation. The inserts 7050 and 7060 are shaped to fit certain apparatus. For this purpose, an insert can be shaped and/or include through holes, protrusions and/or indentations configured to engage with edges, indentations and/or protrusions of an apparatus, respectively.

Inserts may be supplied to a user or be installed during assembly of the film-application device 7000, for example. As such different inserts can be supplied to fit different types of apparatuses. Correspondingly configured multi-layer pads may be supplied to a user or selected during assembly respectively, as different apparatuses may require different types, sizes or other configurations of protective films.

To hold an insert in place and to properly register the insert and subsequently an attached apparatus with the frame, the insert and the frame can include mating features, for example, features 7061 and 7062. Such features can include protrusions, indentations, through holes or other mating features.

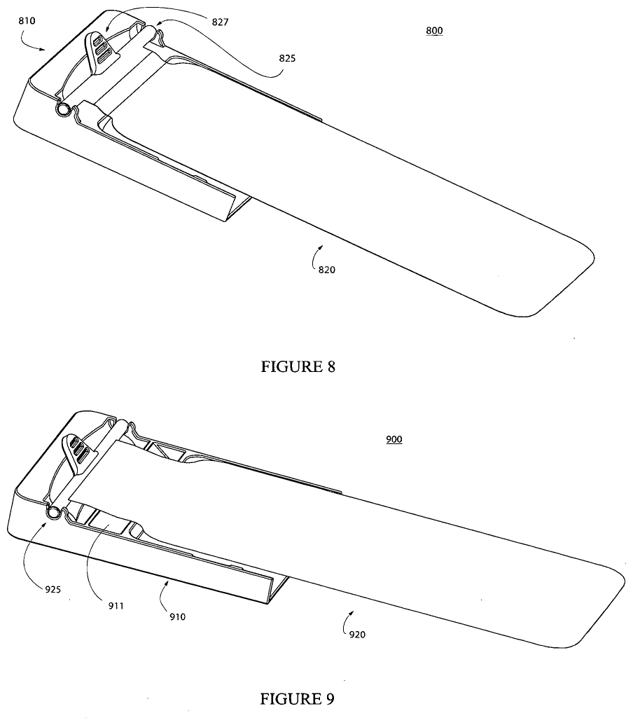

FIG. 8 shows another example film-application device 800 with a frame 810 that is configured to couple resiliently with a pad-support pin 825. The coupling is configured to allow pivoting the pad-support pin 825 relative to the frame 810. The pad-support pin 825 is coupled to a multi-layer pad 820 which includes a protective adhesive film. The pad-support pin 825 can be coupled and decoupled repeatedly from the frame 810 facilitated by a handle 827 attached to the pad-support pin 825. FIG. 9 shows another example film-application device 900 with a frame 910 that is configured to couple resiliently with a pad-support pin 925 and allow pivoting the pad-support pin 925 relative to the frame 910. The example film-application device 900 is similar to the example film-application device 800 but additionally includes a through hole in form of a slit 911 in the frame 910. The slit 911 is shaped and sized to receive a multi-layer pad 920 or portion thereof and thread it through to the bottom side of the frame 910 away from the top intended to face a target surface for film application. The slit 911 can be used to receive and stow away a bottom film that is fixedly attached to the pad-support pin 925 after separation from the multi-layer pad 920.

Depending on the implementation, pad-support pins can be configured to provide one or more multi-layer pads. Pad-support pins may be supplied separately as replacement items and configured to allow multiple film applications using the same frame.

In some implementation, a protective adhesive film is formed from a material that on its own provides sufficient adhesion with the target surface without requiring a separate substance to facilitate adhesion. Depending on the implementation, such adhesive films may be configured to leave no residue on the target surface after removal. In some implementations, a separate adhesive layer may be employed. Such adhesive layers can be configured to leave or not leave residue on the target surface after removal.

Depending on the implementation, film-application devices can comprise different materials such as plastic, metal, compound or other materials, for example. Film-application devices may be formed integrally or from multiple separate components. Separate components can be configured to interlock and allow repeat disassembly and assembly without destruction, or be permanently adhered by gluing, welding, vulcanizing or other means, for example. Integrally formed film-application devices or parts thereof may be injection molded, cast, machined, or otherwise fabricated.

Depending on the implementation, film application devices can be configured to permit reuse, recycling, disposal or other aspects. To limit environmental impacts after intended use, film application devices may be of small size and configured to employ and produce small amounts of waste material.

### Film Application

Returning to FIGS. 1 through 3, the process of film application is being described with respect to example film-application device 100. FIGS. 10A through 10F show examples of steps during film application in which bold arrows indicate directions of force application. To begin film application, the target surface 11 of the mobile phone 10 can be cleaned (not illustrated) in a suitable manner, for example by using a cloth, a cleaning solution or other method. The mobile phone 10 is attached to the frame 110 to establish a properly registered assembly. This can be done after or before cleaning. The bottom film 124 can then be peeled from the multi-layer pad 120 to access the face of the transparent protective adhesive film 123 that is configured to adhere to the target surface 11 of the mobile phone 10. By pulling tab 1241 away from tab 1221, the bottom film 124 can be lifted off the transparent protective adhesive film 123 and fully peeled away. FIG. 10A shows the assembly with a partially removed bottom film 124. After removal, the bottom film 124 can be set aside and/or disposed of. At this point, the portion of the pad 120 that remains coupled with the frame 110 includes the transparent protective adhesive film 123 and top film 122.

The pad 120 can then be taut slightly and the transparent protective adhesive film 123 laid down onto the target surface 11 distal of the supported edge that is coupled with the frame 110. Tabs 1221 and 1223 can be used to conveniently hold and taut the remainder of the pad 120 including the top film 122 and the transparent protective adhesive film 123. FIG. 10B shows the assembly at this stage of the film-application process. As noted, the film-application device 100 is configured to allow a portion of the adhesive film extending from the supported edge to remain slightly elevated above the target surface without further manipulation to avoid inadvertent sagging and/or static cling of the adhesive film onto the target surface 11 once the distal edge of the transparent protective adhesive film 123 is properly aligned with and adhered to the target surface 11. During alignment, outer edges, and/or apertures for buttons, speakers, cameras and so forth provided by the pad 120 can be used as registration aids with respective elements provided by the target surface 11. The example film-application device 100 furthermore, can be configured to allow registration and application of the distal edge of the transparent protective adhesive film 123 while maintaining a comfortable range of tension in the pad 120 that is intuitive to the user.

The elevated portion of the transparent protective adhesive film 123 then can be applied to the target surface by pasting the pad 120 with a spatula 30, cloth or other aid towards the supported edge of the transparent protective adhesive film 123. The spatula 30 can be moved in smooth strokes to mitigate formation of bubbles in the transparent protective adhesive film 123. FIG. 10C shows the assembly at this stage of the film-application process. Tabs 1221 and 1223 are not shown in FIGS. 10C through 10F.

Once sufficient protective adhesive film 123 is pasted onto the target surface 11, the top film 122 can be peeled away and folded back to release the transparent protective adhesive 123 and allow any remaining loose portion of the transparent protective adhesive 123 to be freely and fully pasted onto the target surface 11. FIGS. 10D and 10E show the assembly during and after removal of the top film 122, respectively. At this stage, the transparent protective adhesive film 123 has been pasted completely onto the target surface 11. The mobile phone 10 can then be removed from the frame 110. FIG. 10F shows a perspective view of the assembly after separation with the transparent protective adhesive film 123 applied to the target surface 11 of the mobile phone 10.

It is obvious that the foregoing embodiments of the technology are examples and can be varied in many ways. Such present or future variations are not to be regarded as a departure from the spirit and scope of the technology, and all such modifications as would be obvious to one skilled in the art are intended to be included within the scope of the following claims.

1. A device comprising:
a. a frame configured to couple removably with an apparatus in an attached configuration; and
b. an adhesive film having a first portion coupled with the frame and a second portion distal from the first portion, the adhesive film configured to adhere to a target surface of the apparatus;
wherein in the attached configuration when the adhesive film is taut and the second portion is abutting the target surface of the apparatus, the first portion is being held a distance away from the surface of the apparatus and the second portion registers in a predetermined manner with the target surface of the apparatus.

2. The device of claim 1, wherein the adhesive film is transparent.

3. The device of claim 1 further comprising a bottom film configured to cover and peel from a side of the adhesive film configured to adhere to the target surface.

4. The device of claim 3, wherein the bottom film comprises one or more tabs that protrude beyond the adhesive film and are configured to facilitate peeling the bottom film from the adhesive film.

5. The device of claim 1 further comprising a top film configured to cover and peel from a side of the adhesive film opposite the side configured to adhere to the target surface.

6. The device of claim 5, wherein the top film comprises one or more tabs that protrude beyond the adhesive film and are configured to facilitate registration of the adhesive film with the target surface and peeling the top film from the adhesive film.

7. The device of claim 1, wherein the adhesive film comprises one or more removable tabs.

8. The device of claim 1, wherein the adhesive film extends across predetermined portions of the target surface and includes one or more apertures.

9. The device of claim 1, wherein the frame is configured to extend along a portion of a circumference of the apparatus.

10. The device of claim 1, wherein the frame is configured to establish a friction fit with the apparatus in the attached configuration.

11. The device of claim 1, wherein the frame is configured to clamp resiliently to the apparatus.

12. The device of claim 1, wherein the frame has one or more protrusions configured to mate removably with corresponding indentations provided by the apparatus and register the frame with the apparatus.

13. The device of claim 1, wherein the target surface includes a display provided by the apparatus.

14. The device of claim 1, wherein the apparatus is selected from the group consisting of a mobile phone, a tablet, a laptop computer, a desktop computer, a wrist watch, a camera, a television and a measuring instrument.

15. The device of claim 1, wherein the frame comprises a protrusion protruding beyond the target surface and configured to hold the first portion of the adhesive film said distance away from the target surface.

16. The device of claim 1, wherein when the second portion of the adhesive film is being brought into contact with the target surface, the adhesive film adheres to the surface of the apparatus beginning at the second portion.

17. The device of claim 16, wherein the adhesive film is configured to fully adhere to the surface of the apparatus when the adhesive film is deregistered from the frame.

18. The device of claim 17 further comprising a top film affixed to the frame and configured to register the adhesive film with the frame, the top film removably adhering to a side of the adhesive film that is opposite the side that is configured to adhere to the surface of the apparatus wherein the adhesive film is configured to deregister from the frame when the top film is peeled from the adhesive film.

19. The device of claim 1, wherein the distance is configured to maintain sufficient tension in the adhesive film when the adhesive film is taut to allow to apply initially the second portion of the adhesive film to the surface of the apparatus without inadvertently sagging the first portion of the adhesive film onto the target surface.

20. The device of claim 19, wherein the distance is configured to allow to apply sufficient adhesive film to the surface of the apparatus to maintain registration and proper application of the remaining adhesive film with the target surface after the second portion is adhered to the target surface.

21. The device of claim 1, wherein the frame is configured to support the apparatus in the attached configuration in an inclined orientation relative to a support surface.

22. The device of claim 21, wherein the frame is configured to hold the apparatus in the inclined orientation without allowing rocking the apparatus on the support surface.

23. The device of claim 22, wherein the frame extends along a portion of the apparatus and has a base that is tapered at an angle that supports the apparatus on the support surface in the inclined orientation.

24. The device of claim 1 further including a top and a bottom film adhered to opposite sides of the adhesive film and configured to peel from the adhesive film, wherein the top, bottom and adhesive film are forming a multi-layer pad.

25. The device of claim 24 further comprising multiple of said multi-layer pad and configured to allow multiple applications of respective adhesive films with said frame.

26. The device of claim 6, wherein the adhesive film separates from the frame after peeling off the top film.

27. The device of claim 1, wherein the adhesive film includes a predetermined break line configured to allow separation of the adhesive film from the frame.

28. The device of claim 1, wherein the frame has a base including one or more elements configured to increase friction between the frame and a support surface to mitigate slippage of the device.

29. The device of claim 28, wherein the one or more elements of the base are provided by one or more rubber elements.

30. The device of claim 29, wherein one or more of the elements of the base are adhesive.

31. The device of claim 1, wherein the frame includes one or more indentations configured to receive one or more protrusions provided by the apparatus.

32. The device of claim 12, wherein the frame includes an insert shaped to provide the one or more protrusions.

33. The device of claim 31, wherein the frame includes an insert shaped to provide the one or more indentations.

34. The device of claim 11 further including a retractable resiliently biased arm arranged to clamp and register the apparatus with the frame in the attached configuration.

35. The device of claim 34 further including a spring arranged to resiliently bias the arm and clamp and register the apparatus with the frame in the attached configuration.

36. A film-application device comprising:
a. a frame configured to couple removably with an apparatus in an attached configuration; and
b. a multi-layer pad coupled with the frame and including an adhesive film configured to peel from the pad and adhere to the apparatus, the adhesive film having a first portion close to the frame and a second portion distal from the first portion;
wherein in the attached configuration when the adhesive film is taut and the second portion is registered with the apparatus, the first portion remains distal of the apparatus.
